(19) United States
(12) Patent Application Publication
(10) Pub. No.: US 2026/0015070 A1
(43) Pub. Date: Jan. 15, 2026

(54) Dive computer with software algorithm and graphical user interface presenting necessary information to recreational scuba diver while scuba diving

(71) Applicant: Joshua Heard, Newport Beach, CA (US)

(72) Inventor: Joshua Heard, Newport Beach, CA (US)

(21) Appl. No.: 18/770,495

(22) Filed: Jul. 11, 2024

(51) Int. Cl. B63C 11/02; G06F 9/451

(52) U.S. Cl. CPC B63C 11/02; G06F 9/451; B63C 2011/021

(57) ABSTRACT

A dive computer with software algorithm and graphical user interface that provide critical real-time information to a recreational scuba diver while scuba diving. The algorithm takes depth and time data and the diver's specified options to calculate all the necessary dive information and presents it to the diver in a single graph. Based on the algorithm's calculations, the graphical user interface gives the diver a visual representation of the water column, the diver's depth in the water column, and the corresponding depth limits. The interface shows the diver in real time where the diver is in relation to the water column and shows the diver the depth limits which are too deep or too shallow, and where the diver should be to complete the dive safely.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

### Field of the Invention

B63C11/02 Divers' equipment

B63C 2011/021 Diving computers

### Background

Millions of people enjoy the sport of scuba diving worldwide. To breathe underwater, scuba divers breathe air from a compressed air tank while scuba diving. As scuba divers breathe compressed air, the diver's lungs respirate oxygen, and the diver's body tissues absorb and diffuse nitrogen and other inert gasses. The absorption and diffusion of nitrogen and other inert gasses depends on the duration of the dive (time) and the change in ambient pressure (depth).

If the inert gasses absorbed by the body are not given enough time to diffuse while ascending, harmful bubbles may form in the diver's body tissues potentially causing Decompression Sickness (“DCS”), also known colloquially as “the bends”. Since it is not practical to measure directly nitrogen or other inert gasses in human body tissue during a dive, equations estimate the amount of inert gasses in the diver's body tissues based on the time and depth primarily. Scientists have created and published these equations based on physics and years of experimentation.

Dive computers are electronic devices used to track a diver's depth and time underwater along with various other data. Algorithms are self-contained sequences of action that perform calculations, process data, and automate reasoning tasks on the diver computer. These algorithms take the data and perform the equations in real-time to estimate the absorption and diffusion of nitrogen and other inert gasses. The dive computers then present the relevant results from the algorithms to the diver via a user interface.

Recreational scuba divers want to be able to enjoy the natural beauty of the surroundings without being confronted with an overload of information on the user interface. A problem with current dive computer interfaces is that they present a confusing and complex array of numbers that the diver must analyze while diving, along with unnecessary and irrelevant information. These problems distract from the enjoyment of the sport, increase the risk of making a dangerous mistake, and make the dive computer more difficult to learn and use. There is an improvement needed to present this information to the diver in an intuitive interface and allowing the diver to enjoy better the sport of diving.

### BRIEF SUMMARY OF THE INVENTION

The present patent application relates to a dive computer with a software algorithm and graphical user interface presenting necessary information to scuba diver while scuba diving. The dive computer gives depth and time data to the algorithm which calculates all the necessary information to safely complete a scuba dive. The user interface presents in real-time the three most critical pieces of information to a scuba diver: where the diver is in the water column, whether the diver is going too deep, or whether the diver is going too shallow. The invention is an improvement over current dive computers because it solves the complexity of information presented to the recreational scuba diver while scuba diving.

By providing a novel graphical user interface that gives the diver a visual representation of the water column and the corresponding depth limits, the disclosed exemplary embodiments lower the risks and increase the enjoyment of scuba diving. The graphical user interface provides this information in one simple graph making it easy to use, understand, and learn. The software algorithm and graphical user interface may be used on a dive computer or other form factor usable by a human and capable of processing information such as a watch, smartphone, tablet, or other electronic device.

In the present embodiment, the dive computer may provide the algorithm with depth and time. Based on the algorithm's calculations, the graphical user interface displays the diver's depth and shows the diver the depth limits which are too deep or may be too shallow. The display tells the diver instantly where the diver is in the water column and where the diver should be to complete the dive safely.

In another embodiment, the dive computer may integrate with the algorithm and the graphical user interface. The diver computer may be comprised of a power source, microprocessor, clock, read-only memory, random access memory, an analog to digital converter, a water pressure transducer, and an air pressure transducer. It may be connected to a computer display comprised of a panel that can emit programmable images or other such display device.

### BRIEF DESCRIPTION OF THE DRAWINGS

FIG. 1: The graphical user interface's home screen.

FIG. 2: Graph representing the water column for the dive.

FIG. 3: Graph showing the Current Depth in the water column.

FIG. 4: Graph showing the Maximum Ascent Depth in the water column.

FIG. 5: Graph showing the increase in the Maximum Ascent Depth.

FIG. 6: Graph showing the Current Depth and the Maximum Ascent Depth and the Maximum Descent Depth in the water column.

FIG. 7: Flowchart showing the procedures and methods of the algorithm.

### DETAILED DESCRIPTION OF THE INVENTION

The present embodiment synthesizes all the necessary dive parameters into a single graphical user interface representative of the water column in which the diver is diving making it more intuitive than other dive computers to complete a safe dive and avoid DCS. The algorithm computes, among other things, three critical pieces of information during a dive: the diver's current depth (“Current Depth”), the minimum depth to which the diver can safely ascend to avoid DCS (“Maximum Ascent Depth”), and the maximum diving depth to which the diver can descend and still safely ascend to the surface with the set air reserve (“Maximum Descent Depth”) (The term “Maximum Descent Depth” is different from current dive computers which use the term “Maximum Depth” to refer to the deepest depth the diver has reached on a particular dive).

The scuba diver must know the Maximum Ascent Depth to avoid DCS. As the diver ascends, the diver must not ascend too shallow so that DCS occurs. In the current embodiment, the algorithm calculates the inert gas levels using the scientifically published Buhlmann ZH-16 (1995) equation and other equations, which have been rigorously tested and are in widespread use in dive computers around the world. Based on the calculations of these equations, the algorithm computes the Maximum Ascent Depth, the depth limit to where a diver can safely ascend to avoid DCS.

A diver only has a certain amount of time underwater. This time is limited by the amount of air the diver is carrying, the air consumption rate, the times spent at various depths, and the amount of time it will take to safely reach the surface accounting for relevant decompression requirements. The current embodiment is unique in that it constantly computes this time limit and translates it into a Maximum Descent Depth.

Current dive computers provide the diver with what is known as the Remaining Bottom Time (“RBT”) which is the safe time remaining underwater at the diver's current depth. As the diver changes depth, the RBT changes as well. Since the RBT is constantly changing, it does not provide the diver with precise information about when the diver must ascend or what depth is safe. And since the RBT is a time limit, the diver must maintain concentration on the time countdown. Then when the diver changes depth, the diver must adjust their countdown. This is a distraction to the diver during the dive

An improvement to current dive computers which use RBT, the present embodiment uses the Maximum Descent Depth to inform the diver of exactly where the safe descent limit is. As the Maximum Descent Depth rises based on the amount of air remaining and the decompression requirements, the diver must also ascend to stay within the safe limit. The safe dive limit is presented to the diver graphically as a place in the water column. Instead of a shifting RBT countdown, the diver has a picture of where they must be. All the diver must do is “stay between the lines” of the graph to stay safe. This improved and intuitive feature of the embodiment is less distracting than the current state of the art, allowing for a safer more enjoyable diving experience.

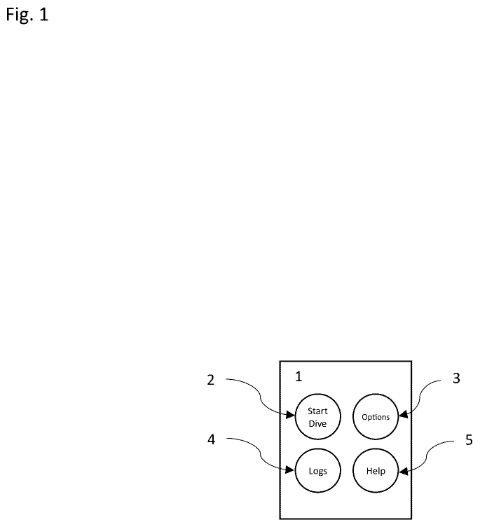

FIG. 1. In the disclosed exemplary embodiment, the graphical user interface's home screen may contain four buttons 1. The diver can choose to start the dive by pressing the “Start Dive” button, or other such implementation (“Button”) 2. The diver can select the “Options” Button to tailor the dive to the diver's individual preferences 3. The diver can select the “Logs” Button to see the dive logs generated by the algorithm 4. And the diver can select the “Help” Button to view a help page where the diver can get help on using and understanding the invention 5. The labels and functions of the buttons may be changed in other embodiments.

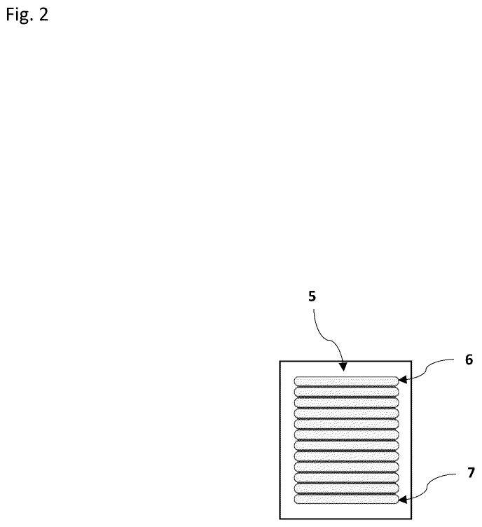

FIG. 2. When pressing the Start Button on the main interface, the algorithm presents the graph screen to the diver. The graph represents the water column for the dive. It may consist of a series of 12 horizontal bars, or other discrete representations such as a dot or other image (“Bar”) 5. In an embodiment of the invention using Imperial measurements, each Bar may represent 10 feet of depth. In another embodiment, the metric system of measurement is used. In that case, each Bar may represent 3 meters. The top of the graph represents the water's surface 6, counting down to the bottom of the graph, which is the recreation dive limit of 120 feet or 36 meters 7. The default color of each Bar may be green, or some other uniform representation, such as a shade or a pattern.

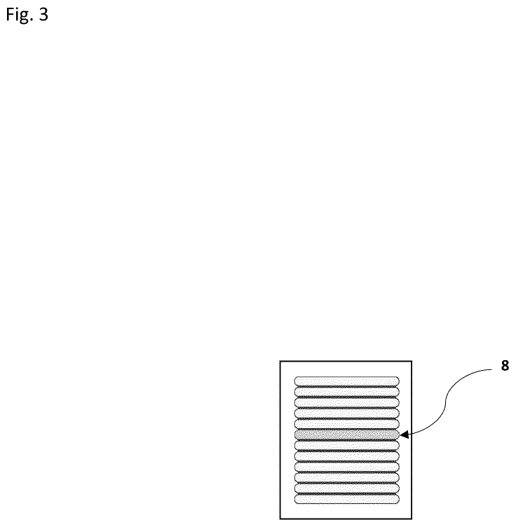

FIG. 3. Knowing the diver's Current Depth in the water column orients the diver to the diver's place in the underwater environment. The Bar representing the diver's Current Depth bar may be blue, or some other representation that distinguishes it from the background bars 8. In an embodiment of the invention using Imperial measurements, the depth range for each Bar is 10 feet: 1-10 feet, 11-20 feet, 21-30 feet, and so on. Therefore, in FIG. 3, the diver's Current Depth is between 61 and 70 feet. In the Metric embodiment, each bar represents 3 meters, so the first bar would be 1-3 meters, the second bar 4-6 meters, and so on. In FIG. 3, the diver's depth would be 18-21 meters. As the diver moves up and down in the water column, the blue Bar moves up or down in real-time according to the diver's Current Depth.

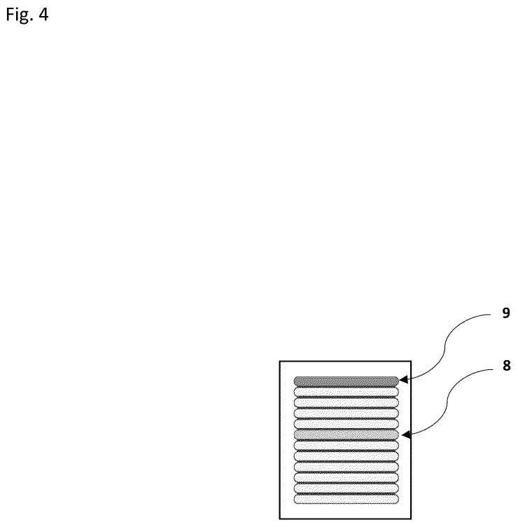

FIG. 4. In addition to the Current Depth 8, the graphical user interface may represent the Maximum Ascent Depth as a red Bar 9, or some other representation that distinguishes it from the background Bars and the Current Depth Bar 8. The Maximum Ascent Depth starts at the top of the graph.

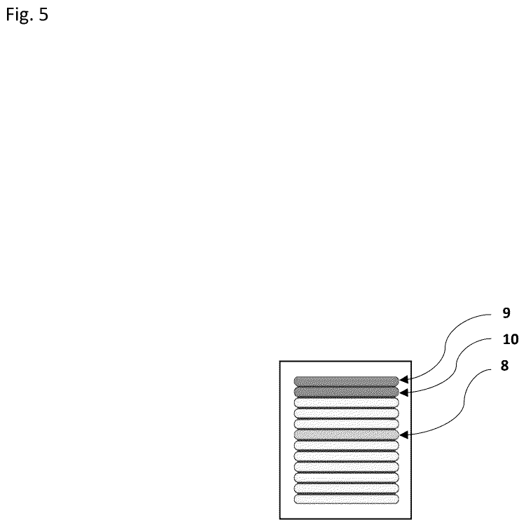

FIG. 5. As the Maximum Ascent Depth increases, more Bars may appear at the corresponding depths starting from the top of the graph and going down the graph of the water column. So, if the Maximum Ascent Depth was 12 feet, the first Bar 9 and the second Bar 10 may be red, or some other representation that distinguishes it from the background Bars and the Current Depth Bar 8. If the diver keeps the Current Depth Bar 8 below the lowest Maximum Ascent Depth Bar 10 during the dive, the diver will conduct a safe dive. If the diver ascends above the Maximum Ascent Depth the Bars will flash, a warning sound will occur, or some other warning or combination of warnings will be given. In that case, the diver should immediately descend until the warnings stop.

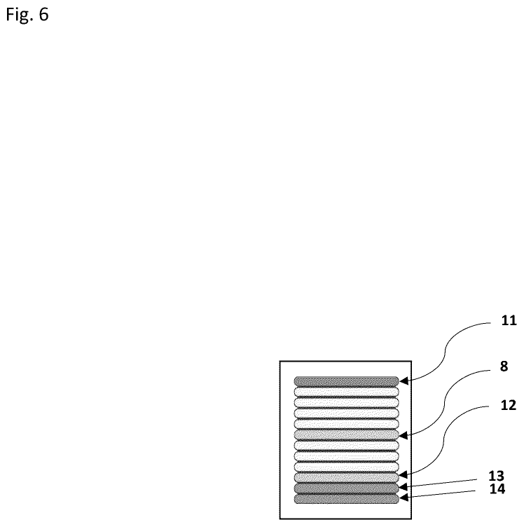

FIG. 6. The current embodiment presents the Maximum Descent Depth on the graphical user interface starting at the bottom of the graph first as yellow warning Bars 12, or some other representation that distinguishes it from the background Bars and the Current Depth Bar 8. Then as the Maximum Descent Depth gets lower, it starts to move up the graph as red Bars 13, then 14, and continuing up the graph. As the Maximum Descent Depth moves up the water column, the yellow then red bars, or some other representation that distinguishes it from the background Bars and Current Depth Bar, move up on the display. The diver can look at the display and easily determine the Maximum Ascent Depth 11 and their corresponding Current Depth 8. As can be seen, the diver must keep the Current Depth between the Maximum Ascent Depth 11 and the Maximum Descent Depth 12. The diver must intuitively stay between these lines.

As the Maximum Descent Depth rises, the diver too should ascend. If the diver is below the Maximum Descent Depth, the red Bars may flash blue and red, or some other representation that distinguishes it from the background Bars and Current Depth Bar, and give an audible or other such warnings. If the diver should perceive these warnings, the diver should begin to ascend until the diver is above the Maximum Descent Depth Bar and the warnings have stopped.

In most cases, a diver must make a Safety Stop, also known as the Decompression Stop. It is a measure of how shallow a diver can get while ascending at the end of the dive. The Safety Stop is a function of time and depth. The embodiment may include a safety stop calculation in its computation for the Maximum Ascent Depth in the algorithm.

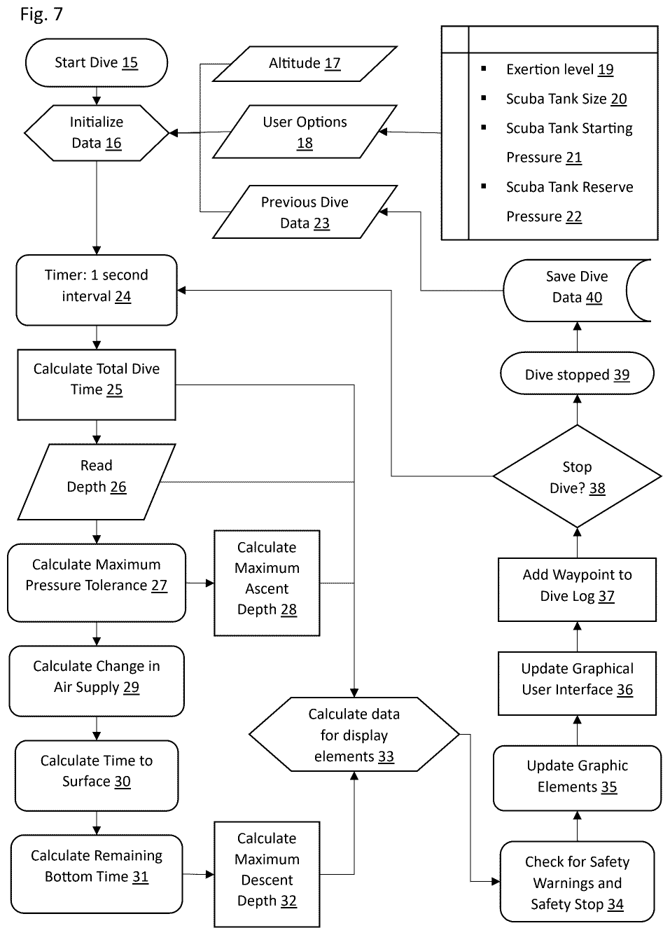

FIG. 7. The disclosed exemplary embodiments' algorithm is a set of logical instructions which runs systematically through a series of steps and provides the outputs for the graphical user interface.

Once the diver presses the Start Dive button on the main screen (FIG. 1), the Start Dive procedure begins 15. The algorithm starts the dive by initializing data 16. The algorithm takes an altitude reading from the hardware sensors 17 to adjust initial ambient pressure. The algorithm then loads the stored User Options 18: Exertion level 19, Scuba tank size 20, Scuba tank starting pressure 21, and Scuba tank reserve pressure 22. The diver can change the User Options to suit their preferences. Any data from the previous dive is loaded into the algorithm if there are multiple dives 23.

The algorithm uses a timer to cycle every one (1) second 24 and calculates the length of the total dive time 25. It reads the depth from the hardware sensor 26. From the depth and time, it computes the Maximum Pressure Tolerance 27 from the Buhlmann equation. From the Maximum Pressure Tolerance, the algorithm calculates the Maximum Ascent Depth 28.

The algorithm then calculates the diver's Change in Air Supply 29, the Time to Surface 30, which is the time it would take the diver to get to the surface making a normal ascent, and the Remaining Bottom Time 31. The algorithm then uses these values to calculate the Maximum Descent Depth 32.

The algorithm then updates the graphical user interface by first calculating the data for each of the display elements 33, then performing a Check for Safety Warnings and Safety Stop 34. It then updates the individual Graphic Elements 35. It then Updates the Graphical User Interface 36. Finally, it adds a waypoint to the dive log 37.

The process repeats every second to update the diver in real-time until the dive is stopped by the diver 38. When the dive is stopped 39 the dive data is stored in the event there are multiple dives 40.

1. A dive computer with a software algorithm and a graphical user interface which provides critical real-time information to a scuba diver while scuba diving. The algorithm takes real-time depth and time data and calculates all necessary information presenting it graphically to the diver to safely complete scuba dive. Based on algorithm's calculations, the graphical user interface gives diver visual representation of water column, diver's depth in water column, and corresponding depth limits, all in single graph.

2. An improved graphical user interface consisting of bars (dots, lines, or other symbols) representing the water column, including representations for the following depths: Current Depth, Minimum Ascent Depth, Maximum Descent Depth, with the depths differentiated from the background.

3. A novel graphical user interface which gives a visual real-time representation of the water column during a scuba dive that shows the scuba diver a safe zone, which is not too deep or too shallow, based on the algorithm's calculations, telling the scuba diver instantly where the diver is in the water column and where the scuba diver should be to complete the dive safely.
